(19) United States
(12) Patent Application Publication
(10) Pub. No.: US 2025/0290348 A1
(43) Pub. Date: Sep. 18, 2025

(54) SYSTEM, METHOD, APPARATUS FOR DETECTION OF MAGNETIC TAMPERING OF DOOR LOCKS

(71) Applicant: Schlage Lock Company LLC, Carmel, IN (US)

(72) Inventors: Niveditha Shet, Mangalore (IN); Manjunatha H. V., Shivamogga (IN); Sujith Kumar Reddy, Telaprolu Village (IN)

(21) Appl. No.: 18/606,101

(22) Filed: Mar. 15, 2024

(51) Int. Cl. E05B 47/00

(52) U.S. Cl. CPC E05B 47/0012; E05B 2047/002; E05B 2047/0036; E05B 2047/0069

(57) ABSTRACT

A deadbolt system includes a stationary magnetic sensor that senses magnetic field values from at least one of the first and second magnets while rotating one or more gears that drive a deadbolt between extended and retracted positions during locking and unlocking operations. A controller compares the sensed magnetic field values during the rotating with expected magnetic field values. A tamper condition is determined in response to the sensed magnetic intensity falling outside a predetermined range for the expected magnetic intensity.

### BACKGROUND

Door locks can include deadbolts that are electronically controller and mechanically driven between extended and retracted positions. For example, a drive assembly with an electric motor can be provided that is controlled to drive the deadbolt between locked and unlocked positions using a driver bar connected to a rotatable output shaft that is driven by a gear train. The gear train includes a final gear that, when driven by the motor, rotates in one direction or the other to extend or retract the deadbolt.

Once the deadbolt is driven to the locked or unlocked position, the motor has to rotate in the opposite direction to bring the gear train back to a certain position so that manual actuation of the deadbolt will be possible without obstruction from the gear train. For this purpose, magnets are embedded in the final gear and a primary stationary magnet sensor is placed at a fixed location so that, after actuating the deadbolt, the lock can re-position the final gear by rotating until one of the final gear magnets is within proximity to the primary stationary magnetic sensor, thereby allowing manual actuation of the deadbolt.

Such systems typically employ a second stationary magnetic sensor for tamper detection that is close to the primary magnetic sensor, but far enough away to not be effected by the magnets that are embedded in the final gear. If the second stationary magnetic sensor detects a magnetic field, the door lock controller can provide an alert that there is a tamper condition. However, employing the second stationary magnetic requires additional cost for the sensor and hardware modifications to accommodate it. Therefore, further improvements in this technological area are needed.

### SUMMARY

Embodiments are directed to unique systems, apparatuses, and methods for detection of magnetic tampering of electronically controlled door locks without the use of a second stationary magnetic sensor. Other embodiments are directed to apparatuses, systems, devices, hardware, methods, and combinations thereof for detecting tampering of an electronically controlled door lock by an external magnetic field.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a perspective view of a deadbolt system with the deadbolt in a retracted or unlocked position and a final gear in a home position;

FIG. 2 is a perspective view of the deadbolt system of FIG. 1 with the deadbolt in an extended or locked position and the final gear in the home position;

FIG. 3 is an elevational view of a deadbolt system similar to FIG. 1 but opposite handed and with the deadbolt in a retracted or unlocked position with the final gear angularly displaced from the home position;

FIG. 4 is an elevational view of the deadbolt system of FIG. 3 with the deadbolt in a retracted or unlocked position with the final gear in the home position;

FIG. 5 is an elevational view of the deadbolt system of FIG. 3 with the deadbolt in an extended or locked position with the final gear angularly displaced from the home position;

FIG. 6 is an elevational view of the deadbolt system of FIG. 3 with the deadbolt in an extended or locked position with the final gear in the home position;

FIG. 7 is a simplified block diagram of at least one embodiment of a computing device for use in the dead bolt systems of FIGS. 1 and 3;

FIG. 8 is a graphical illustration of magnetic sensor readings during rotation of the final gear of the deadbolt systems of FIGS. 1 and 3;

FIG. 9 is a graphical illustration of various magnetic field states associated with the electric motor and final gear of the deadbolt systems of FIGS. 1 and 3 during a forward mode and reverse mode of an unlocking operation;

FIG. 10 is a graphical illustration of various magnetic field states associated with the electric motor and final gear of the deadbolt systems of FIGS. 1 and 3 during a forward mode and a reverse mode of a locking operation;

FIG. 11 is a flow diagram of an embodiment of a process for determining a tamper condition of the deadbolt systems of FIGS. 1 and 3 during the forward mode of operation; and

FIG. 12 is a flow diagram of an embodiment of a process for determining a tamper condition of the deadbolt systems of FIGS. 1 and 3 during the reverse mode of operation.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

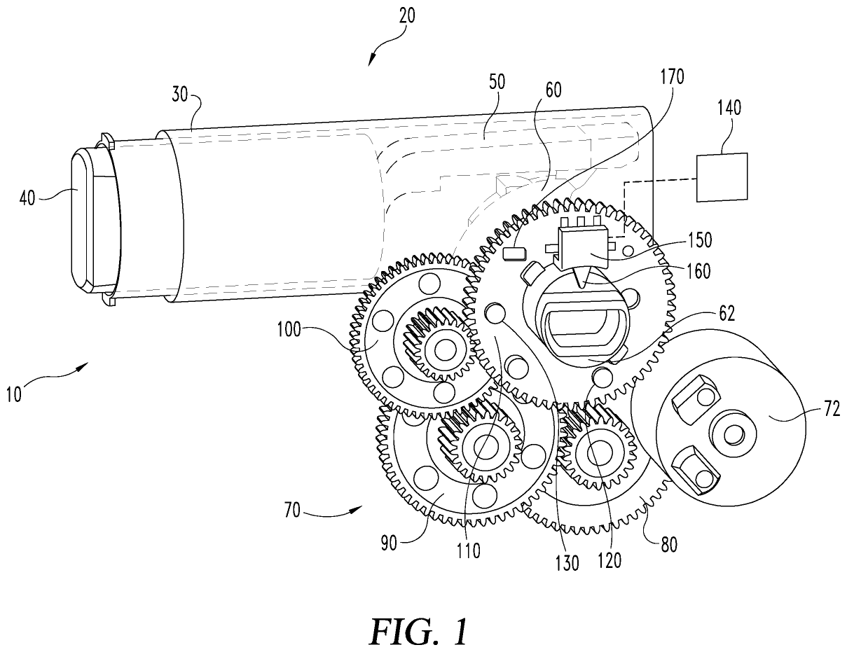

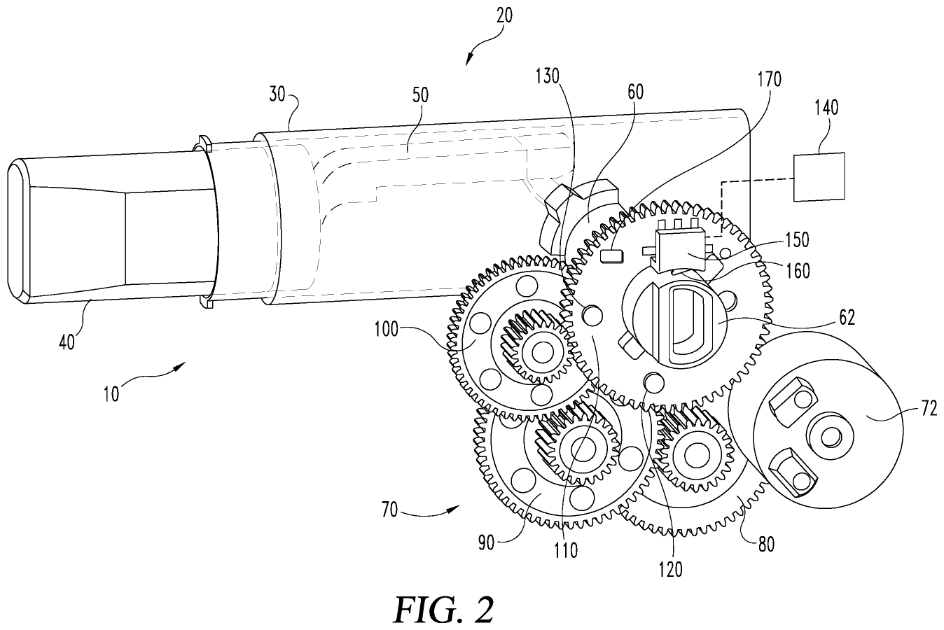

Referring to FIGS. 1 and 2, perspective views of an embodiment of a left-handed deadbolt system 10 are illustrated in an unlocked and a locked configuration, respectively. The deadbolt system 10 includes a deadbolt mechanism 20 that includes a housing 30, a deadbolt 40 and a driver bar 50 operably connected to a rotatable output shaft 60. The rotatable output shaft 60 is operably connected to a gear train 70. The rotatable output shaft 60 also includes a cam 62 operably coupled thereto. The gear train 70 can include one or more gears, and the illustrated embodiment includes a first gear 80, a second gear 90, a third gear 100, and a fourth or final gear 110. Other arrangements and/or number of gears for gear train 70 are also contemplated and not precluded. The final gear 110 is coupled to the output shaft 60 such that when an electric motor 72 rotates in one direction or the other, the gear train 70 will rotate to either lock or unlock the deadbolt 40.

In the locked position, the deadbolt 40 is in an extended position and in the unlocked position, the deadbolt 40 is in a retracted position. The final gear 110 includes a first magnet 120 operably attached or coupled thereto. Final gear 110 also includes a second magnet 130 spaced apart from the first magnet 120 also operably coupled or attached thereto. First and second magnets 120, 130 are opposite in polarity. For example, one of first and second magnets 120, 130 can be a north pole magnet, and the other of first and second magnets 120, 130 can be a south pole magnet. One of the first and second magnets 120, 130 defines a home position for the deadbolt system 10 in a left hand configuration, and other one of the first and second magnets 120, 130 defines a home position in a right hand configuration. The left hand and right hand refer to which side of the door that the deadbolt system 10 is located. In the illustrated embodiment of FIGS. 1-2, second magnet 130 defines the home position for deadbolt system 10.

Deadbolt system 10 further includes a controller 140 that is used to calibrate and control the locking and unlocking operations, and also to detect tamper conditions, motor stall conditions, and/or motor timeout conditions, as discussed further below. Controller 140 receives outputs from a stationary magnetic sensor 170 that senses the magnetic field of each of the first and second magnets 120, 130 during rotation of final gear 110. In an embodiment, stationary magnetic sensor 170 senses an intensity or flux of the magnetic field and provides the sensed readings of the magnetic field value to controller 140. The stationary magnetic sensor 170 may be a Hall Effect sensor in certain embodiments that is electrically connected to a circuit board of controller 140.

As discussed further below, controller 140 can be configured to automatically prevent or hinder unlocking of the deadbolt system 10 when a tamper condition is detected without the use of a second stationary magnetic sensor to sense a magnetic field external to or not part of deadbolt system 10. In this manner, the control system prevents an unauthorized person from “fooling” the controller 140 into unlocking the deadbolt system 10 without the proper electronic credentials. Although not shown, the deadbolt system 10 can include one or more housings to hold various components of controller 140 and/or stationary magnetic sensor 170.

A calibration procedure determines if the deadbolt system 10 is left-handed or right-handed. The home position of the magnet 120, 130 can be determined during this calibration. The first and second magnets 120, 130 are oriented on the final gear 110 so that they have opposite or reverse polarities. For example, if the first magnet 120 has a positive pole facing in one direction, then the second magnet 130 will have a negative pole facing in that same direction. A calibration procedure can also determine expected magnetic field values to be sensed by stationary magnetic from each of the first and second magnets 120, 130 as they move past stationary magnetic sensor 170 during rotation of final gear 110.

Controller 140 is operable for receiving and transmitting command signals and perform computational processing may be located in controller 140 and/or in another or remote computing device. A flipper or bolt position switch 150 is also in electrical communication with the controller 140. The flipper switch 150 includes a pivot finger 160 that is engageable with the cam 62 on the output shaft 60. The pivot finger 160 will be pivotably placed in one direction or the other based on the direction that electric motor 72 rotates the gear train 70.

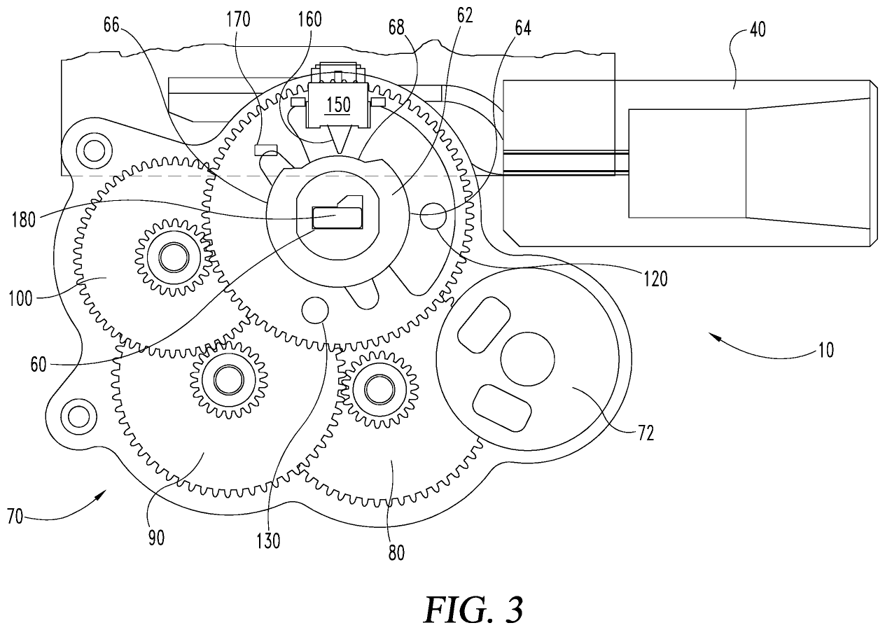

Referring to FIG. 3, an embodiment of deadbolt system 10 that is similar to the embodiments in FIGS. 1-2 is shown but in a right handed orientation. FIG. 3 shows an elevational view of the deadbolt system 10 in a retracted or unlocked configuration. Final gear 110 is rotated counter-clockwise from a home position to retract deadbolt 40 and is positioned away from the home position. The home position defines a position of the final gear 110 in which first magnet 120 is aligned with stationary magnetic sensor 170 to permit a thumb-turn shaft 180 to rotate and lock or unlock the deadbolt 40. A thumb-turn lever (not shown) can be connected to the thumb-turn shaft 180 to permit manual locking or unlocking of the deadbolt system 10, as is commonly done with lock systems.

The deadbolt system 10 is in a home position when first magnet 120 or second magnet 130, depending on the lock handedness, is aligned with the stationary magnetic sensor 170. When final gear 110 is not in a home position, the thumb-turn shaft 180 is lockingly engaged through the output shaft 60 and the gear train 70 and is prevented from rotating independently of the final gear 110. In the home position, the thumb-turn shaft 180 is free to lock or unlock the deadbolt through manual actuation. The first magnet 120 can be configured to define the home position for the right-handed deadbolt system 10 such as shown in FIGS. 3-6, and the second magnet 130 can be configured to define a home position for a left-handed deadbolt system 10 such as shown in FIGS. 1-2. Alternatively, the first and second magnets 120, 130 can be reversed.

The cam 62 includes a right hand actuation profile 64, a left hand actuation profile 66 and a center profile 68 positioned between the right hand profile 64 and the left hand actuation profile 66. The left and right cam profiles 64, 66 have a radius large enough to engage with the pivot finger 160 of the flipper switch 150. The center cam profile 68 has a smaller radius such that the pivot finger 160 of the flipper switch 150 will not engage with cam 62.

In the right hand embodiment of FIGS. 3-6, the output shaft 60 can be rotated counter-clockwise with the electric motor 72, such that the right hand actuation profile 64 will engage with the pivot finger 160 causing the pivot finger 160 to pivot to the left in a clockwise direction about a pivot axis within the flipper switch 150. Likewise, when the output shaft 60 is rotated in a clockwise direction with the electric motor 72, the pivot finger 160 will pivot to the right in a counter-clockwise direction about its pivot axis. The direction that the pivot finger 160 pivots depends on the direction of rotation of the output shaft 60.

The flipper switch 150 sends a signal to the controller 140 and the controller 140 uses this information to determine where the deadbolt 40 is currently positioned. When the electric motor 72 current reaches a threshold limit or stall condition, the controller 140 will signal that the deadbolt 40 has reached a maximum travel location and the controller 140 will stop the electric motor 72.

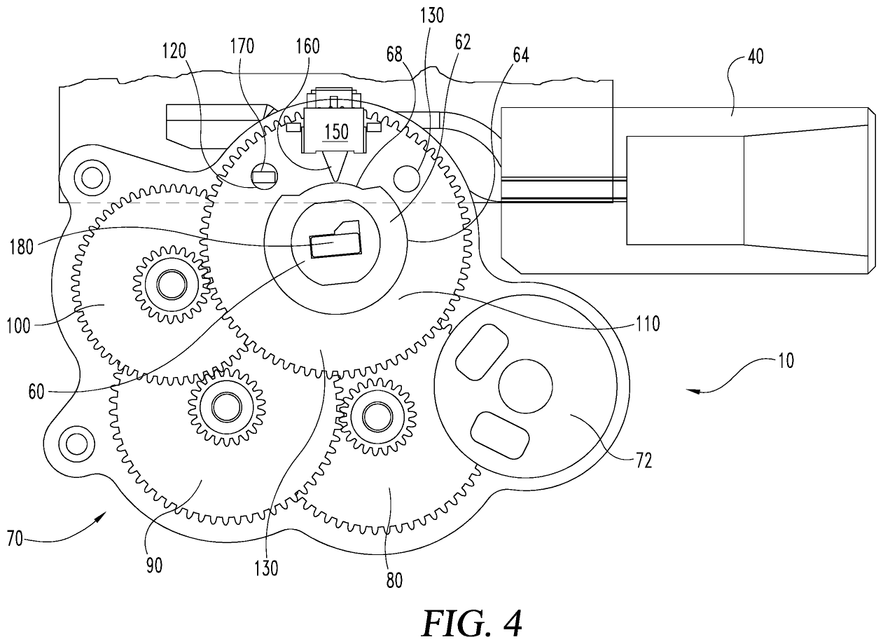

Referring now to FIG. 4, the deadbolt system 10 is shown in similar configuration as FIG. 3, with the deadbolt 40 in a retracted or unlocked position after an unlocking operation, however the final gear 110 has been rotated clockwise by electric motor 72 to a home position such that the first magnet 120 is aligned with the stationary magnetic sensor 170. As explained above, in this position, the thumb-turn shaft 180 can independently rotate the output shaft 60 through manual operation to lock or unlock the deadbolt 40.

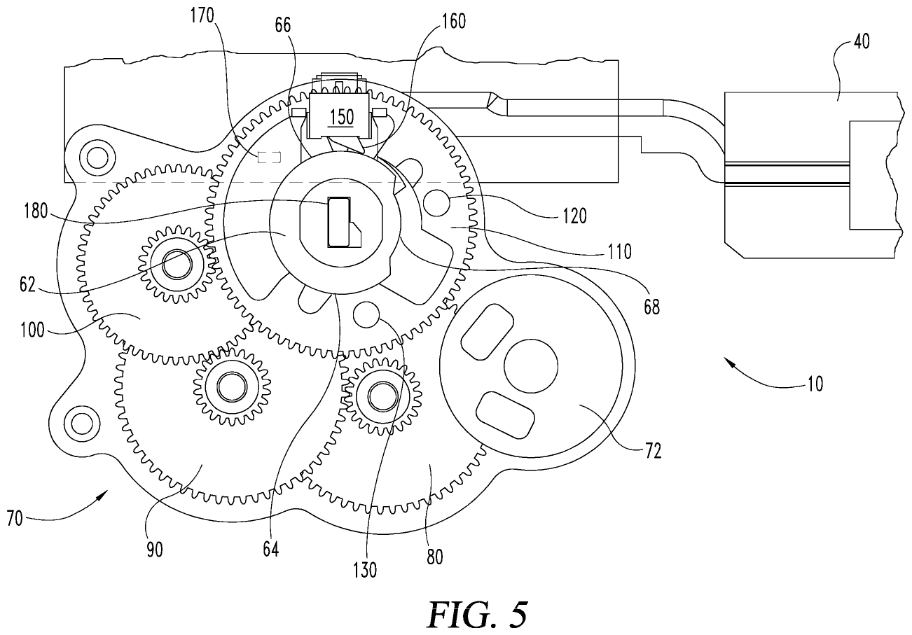

Referring now to FIG. 5, a cross-section view of the deadbolt system 10 is shown with the deadbolt 40 in an extended or locked position. The final gear 110 is rotated clockwise by electric motor 72 and the left hand profile 66 of the cam 62 is engaged with the pivot finger 160 causing the flipper switch 150 to signal to the controller 140 that the deadbolt 40 is in the extended position. Neither the first magnet 120 nor the second magnet 130 is aligned with the stationary magnetic sensor 170. Therefore, the deadbolt system 10 is not located in the home position and the thumb-turn shaft 180 cannot be manually actuated in this configuration.

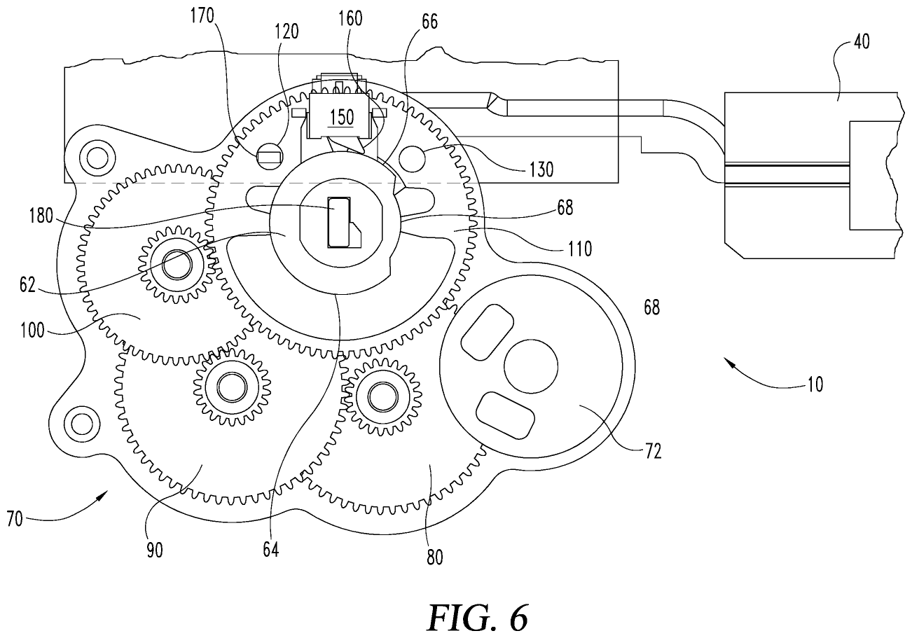

Referring now to FIG. 6, after controller 140 moves the deadbolt 40 to the extended position in a locking operation to lock the deadbolt system 10 as shown in FIG. 5, controller 140 reverses the direction of rotation of the final gear 110 to the counterclockwise direction so as to align the first magnet 120 with the stationary magnetic sensor 170. The pivot finger 160 of the flipper switch 150 remains pivoted towards the right thus confirming that the deadbolt 40 is still in the extended or locked position, however the thumb-turn shaft 180 is now disengaged from the final gear 110, and thus the thumb-turn shaft 180 can be manually actuated to lock or unlock the deadbolt 40.

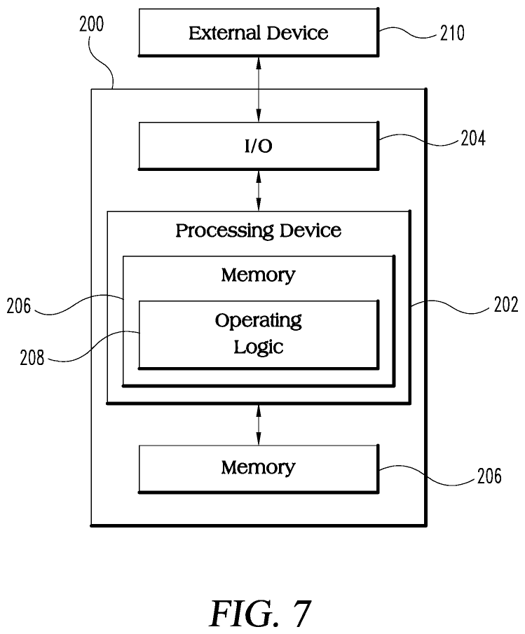

It should be appreciated that each of the controller 140 and any other electronic device associated with deadbolt system 10 may be embodied as one or more computing devices similar to the computing device 200 described below in reference to FIG. 7. For example, in the illustrative embodiment, controller 140 includes a processing device 202 and a memory 206 having stored thereon operating logic 208 for execution by the processing device 202 for operation of the corresponding device.

Although only one controller 140 is shown in the illustrative embodiment of FIG. 1, the deadbolt system 10 may include multiple process controllers in other embodiments. For example, as indicated above, the controller 140 may be embodied as multiple controllers for performing multiple functions. Alternatively or additionally, controller 140 may be configured to perform operations other than deadbolt extension and retraction and tamper detection. For example, controller 140 may perform one or more access control functions, such as credential reading, credential management, etc.

Referring now to FIG. 7, a simplified block diagram of at least one embodiment of a computing device 200 is shown. The illustrative computing device 200 depicts at least one embodiment of controller 140 that may be utilized in connection with the deadbolt system 10 illustrated in FIG. 1. Depending on the particular embodiment, computing device 200 may be embodied as a microprocessor, control unit, reader device, credential device, access control device, server, desktop computer, laptop computer, tablet computer, notebook, netbook, Ultrabook™, mobile computing device, cellular phone, smartphone, wearable computing device, personal digital assistant, Internet of Things (IoT) device, control panel, processing system, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as an access control device, a management system, a mobile device, a management server, and/or an access control panel. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is of a programmable variety that executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable variety, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

Referring now to FIG. 8, graphical illustration 800 shows example magnetic field values sensed by stationary magnetic sensor 170 during rotation of final gear 110 of deadbolt system 10 without the presence of any external magnetic fields. The magnetic field values, which can indicated magnetic field strength, intensity, flux, or other suitable indication for the magnetic field of first and second magnets 120, 130 relative to stationary magnetic sensor 170, are sent to controller 140 and define a characteristic of the expected magnetic field values created by rotation of final gear 110 by the operation of electric motor 72. For example, as the first and second magnets 120, 130 pass stationary magnetic sensor 170, peak magnetic field values 802, 804 are sensed, respectively. Since the first and second magnets 120, 130 are of opposite polarity, peak 802 is positive and peak 804 is negative.

The characteristics of the magnetic field values that are generated by first and second magnets 120, 130 and sensed by stationary magnetic senor 170 during rotation of final gear 110 is used to determine expected magnetic field values for the various rotational positions of final gear 110. The expected magnetic field values may be determined during calibration by controller 140, or programmed as a model into a memory of controller 140. During subsequent rotation of final gear 110 with electric motor 72, if the measured or sensed magnetic field values do not fall within a predetermined threshold of and/or fall outside a range of the expected magnetic field values, then an external magnetic field is present and a tamper condition of deadbolt system 10 can be flagged or indicated.

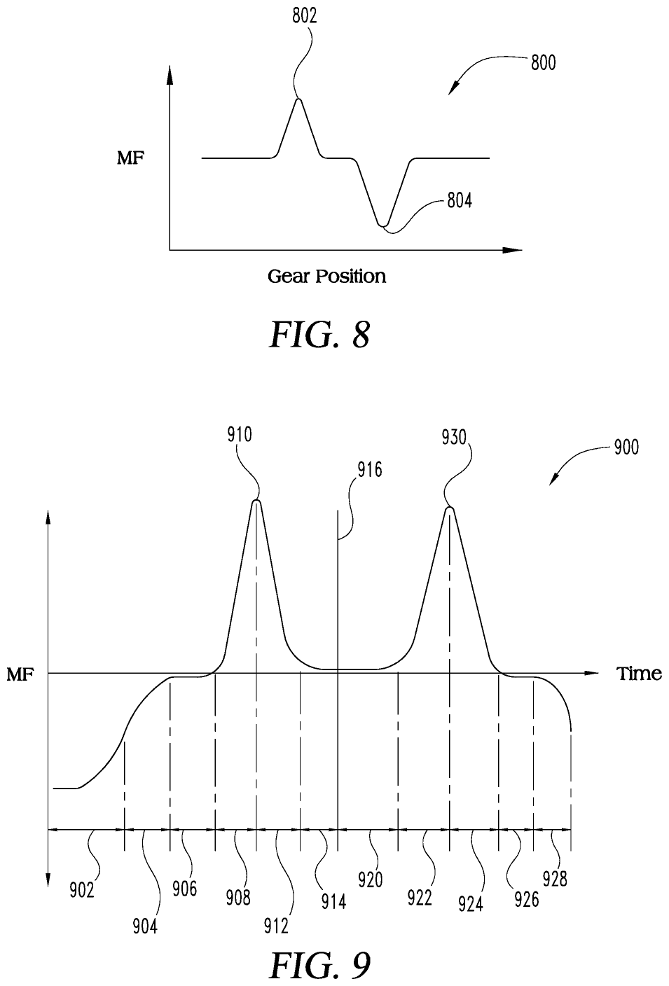

Referring to FIG. 9, there is illustrated an embodiment of a behavior model or state machine 900 which can be programmed into controller 140. State machine 900 models various magnetic field values that are expected during the operation of electric motor 72 and at various states of position of final gear 110 during forward and reverse modes of an unlocking operation. Each of the states are defined based on a range of expected magnetic field values at the various positions of final gear 110. The behavior model or state machine in FIG. 9 allows a comparison of the sensed magnetic field values to the expected magnetic field values or expected magnetic value ranges at every instant of rotation of final gear 110. A tamper condition can be identified if the deviation between the sensed and expected values is greater than a threshold amount, and/or if the sensed value falls outside a range of expected values.

State machine 900 defines a time or location 916 for final gear 110 at which deadbolt 40 is completely retracted during the unlocking operation. Electric motor 72 and final gear 110 operate in a forward mode up to location 916 at which the bolt 40 is unlocked. Electric motor 72 and final gear 110 then operate in a reverse mode after location 916 in order to return final gear 110 to the home position.

The forward mode of the unlocking operation includes a ramp state 902 in which state machine 900 waits until a certain magnetic field value is measured indicating final gear 110 is in the home position. State machine 900 then transitions to a forward start state 904 in which increasing magnetic field values are expected up to a forward mid state 906. The magnetic field values increase more slowly during mid state 906 that in the forward start state, from a value just below zero to a value just above zero. State machine 900 then enters forward rise state 908 in which the magnetic field values increase rapidly to peak 910.

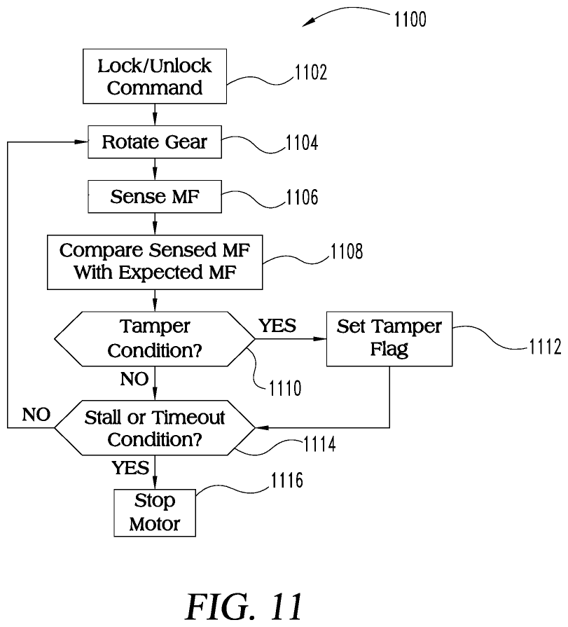

After peak 910, state machine 900 enters a forward fall state 912 in which the magnetic field values rapidly decrease toward zero. As the rate of decrease in magnetic field values levels off, state machine 900 enters forward end state 914 until reaching location 916. If the magnetic field values deviate from the state machine expected magnetic field value at peak 910 by more than a threshold amount, and/or fall outside a range of expected magnetic field values for one or more of the states 904, 906, 908, 912, and/or 914, a tamper condition is present and electric motor 72 continues to operate until it stalls or a timeout condition is met. Since a tamper condition was determined to be present, an alarm or other indicator can be raised, and operation in the reverse mode is aborted. An embodiment of a process for determining a tamper condition during the forward mode using state machine 900 is discussed further below with respect to FIG. 11.

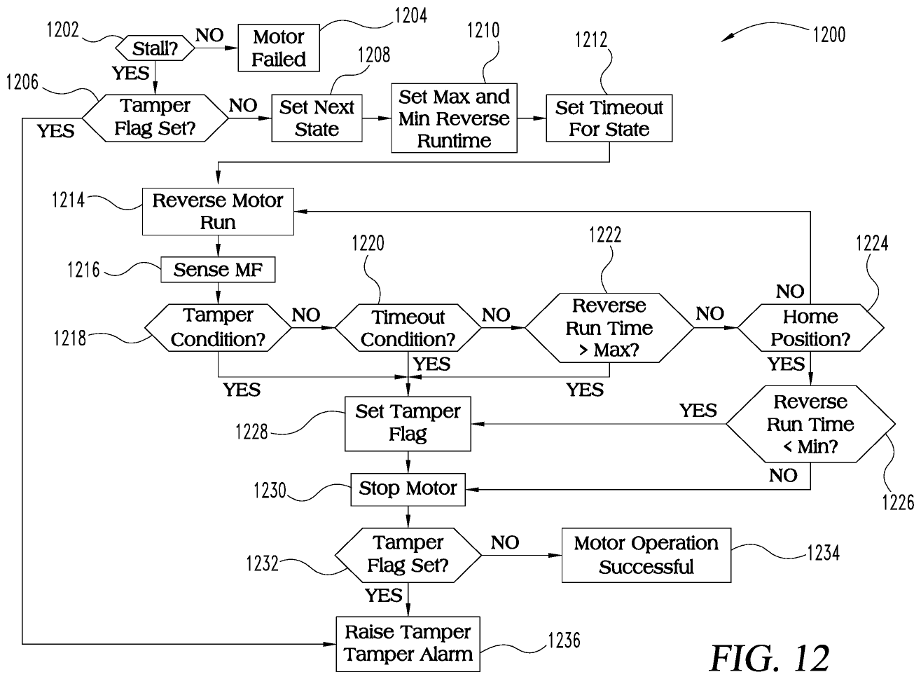

If the sensed magnetic field values follow the various expected magnetic values for state machine 900, then no tamper condition is indicated. Electric motor 72 is then controlled to operate in reverse mode from location 916 back to the home position. In the reverse mode, state machine 900 includes a reverse mid state 920 starting from location 916 in which the magnetic field values are relatively flat. State machine 900 then enters a reverse rise state 922 in which the magnetic field values rise rapidly to peak 930, and a reverse fall state 924 in which the magnetic field values decline rapidly to a reverse end state 926. The magnetic field values decline more slowly during the reverse end state 926 until reaching a reverse home state 928 in which final gear 110 is positioned into the home position. An embodiment of a process for determining a tamper condition during the reverse mode using state machine 900 is discussed further below with respect to FIG. 12.

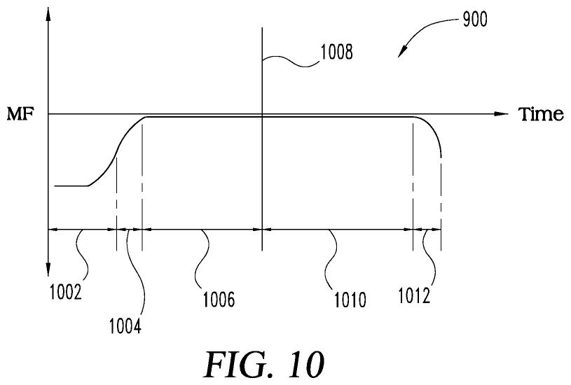

Referring to FIG. 10, there is illustrated state machine 900 modelling various magnetic field states associated with electric motor 72 and final gear 110 during forward and reverse modes of a locking operation. In the locking operation, there is a location 1008 in which deadbolt 40 is fully extended to a locked position by operating electric motor 72 and final gear 110 in a forward mode of operation. Final gear 100 is then reversed from location 1008 to the home position in a reverse mode of operation

The forward mode includes a ramp state 1002 in which state machine 900 waits until a certain magnetic field is measured indicating final gear 110 is in the home position. State machine 900 then transitions to a forward start state 1004 in which increasing magnetic field values are expected up to a forward end state 1006. The magnetic field values are flat along forward end state 1006 since first and second magnetic 120, 130 are both too far from stationary magnetic sensor 170 to sense a value for the magnetic field.

If the sensed magnetic field values deviate from the state machine values by more than a threshold amount, or fall outside a range of expected magnetic field values, at one or more of the states 1004, 1006, a tamper condition is present and electric motor 72 continues to operate until it stalls or a timeout condition is met. Since a tamper condition was determined to be present, an alarm or other indicator can be raised, and operation in the reverse mode is aborted. An embodiment of a process for determining a tamper condition during the forward mode using state machine 900 is discussed further below with respect to FIG. 11.

If the sensed magnetic field values follow the various states 1004, 1006 of state machine 900 during the locking operation, then no tamper condition is indicated. Electric motor 72 is then controlled to operate in reverse mode from location 1008. State machine 900 includes a reverse end state 1010 in which the magnetic field values are relatively flat, and a reverse home state 1012 in which final gear 110 is positioned in the home position. An embodiment of a process for determining a tamper condition during the reverse mode using state machine 900 is discussed further below with respect to FIG. 12.

Various conditions can indicate a tamper condition during operation of deadbolt system 10. For example, if at any time during operation of electric motor 72, the sensed magnetic field value exceeds a maximum positive magnetic value or minimum negative magnetic value determined during calibration, a tamper condition can be indicated. In another example, a tamper condition can be indicated if the sensed magnetic field value is out of range for any of the expected magnetic field values for a corresponding state of state machine 900. In another example, a tamper condition can be indicated if the forward mode of operation stalls without seeing the forward start state 904, 1004. In another example, a tamper condition can be indicated if a timeout condition occurs during any of the states indicating the final gear 110 has not moved through a particular state in an allotted amount of time. In another example, a tamper condition can be indicated if the home position is reached after a maximum run time or before a minimum run time for the reverse mode of operation.

Referring to FIG. 11, a flow diagram of a process 1100 for determining a tamper condition for deadbolt system 10 during a forward mode of operation is illustrated. Process 1100 includes an operation 1102 for receiving a lock/unlock command at controller 140. Process 1100 continues at operation 1104 to rotate at least one gear, such as final gear 110, with electric motor 72. During rotation of final gear 110, process 1100 includes an operation 1106 to sense the magnetic field created for first and second magnets 120, 130 with stationary magnetic sensor 170.

Process 1100 continues at operation 1108 to compare the sense magnetic field value(s) with expected magnetic field value(s) at controller 140. For example, the sensed magnetic field values can be compared with maximum and minimum peak magnetic field values determined from calibration or modelling, and/or expected magnetic field values or expected ranges of magnetic field values for a particular state based on a behavior model or state machine 900 programmed or stored in controller 140. Process 1000 continues at conditional 1110 to determine if a tamper condition is present based on the comparison at operation 1108.

If conditional 1100 is YES, process 1100 continues at operation 1112 to set a tamper flag. From operation 1112, or if conditional 1100 is NO, process 1100 continues at conditional 1114 to determine if a stall condition and/or a timeout condition has occurred during operation of electric motor 72. If conditional 1114 is NO, process 1100 returns to operation 1104 to continue to rotate final gear 110 by operation of electric motor 72. If conditional 1114 is YES, process 1100 continues at operation 1116 and stops electric motor 72.

Referring to FIG. 12, a flow diagram of a process 1200 for determining a tamper condition for deadbolt system 10 during a reverse mode of operation is illustrated. Process 1200 includes a conditional 1202 to determine if a stall condition occurred during the preceding forward mode of operation to extend or retract deadbolt 40. If conditional 1202 is NO, process 1200 continues at operation 1204 to determine electric motor 72 has a failed condition.

If conditional 1202 is YES, then the deadbolt 40 has completely extend or retracted, and process 1200 continues at conditional 1206 to determine of the tamper flag has been set during the forward mode of operation. If conditional 1206 is YES, process 1200 continues at operation to raise the tamper alarm at operation 1236 and the reverse mode is terminated. If conditional 1206 is NO, process 1200 continues at operations 1208, 1210, and 1212 to set various parameters for the reverse mode of operation. For example, operation 1208 sets the next reverse mode state from state machine 900, operation 1210 sets maximum and minimum reverse run times for the reverse mode of operation, and operation 1212 sets timeout limits for the reverse mode states 920, 922, 924, 926, 928 of the unlocking operation or for the reverse mode states 1010, 1012 of the locking operation.

After setting reverse mode parameters at operations 1208, 1210, 1212, process 1200 continues at operation 1214 to operate electric motor 72 to rotate final gear 110 in the reverse mode of operation toward the home position. Process 1200 includes an operation 1216 to sense the magnetic field with stationary magnetic sensor 170 during the reverse motor run. Process 1200 monitors the parameters set at operations 1208, 1210, 1212 at conditional 1218 for a tamper condition determination (such as by comparing the sensed magnetic field values with the expected magnetic field values from state machine 900 as discussed above), at conditional 1220 for a timeout condition determination, and at conditional 1222 for a determination if the maximum reverse run time has been exceeded. If any of conditionals 1218, 1220, 1222 are YES, process 1200 sets a tamper flag at operation 1228.

If conditionals 1218, 1220, 1222 are NO, process 1200 continues at conditional 1224 to determine if the home position for final gear 110 has been reached. If conditional 1224 is NO, process 1200 returns to operation 1214 to continue the reverse mode of operation. If conditional 1224 is YES, process 1200 continues at conditional 1226 to determine if the reverse mode run time was less than the minimum reverse run time. If conditional 1226 is YES, process 1200 continues at operation 1228 to set the tamper flag. If conditional 1226 is NO, or after operation 1228, process 1200 continues at operation 1230 to stop operation of electric motor 72.

Process 1200 continues from operation 1230 at conditional 1232 to determine if a tamper flag has been set during process 1200. If conditional 1232 is NO, the operation of electric motor 72 and positioning of final gear 110 is determined to be successful at operation 1234. If conditional 1232 is YES, process 1200 continues at operation 1236 to raise a tamper alarm. The tamper alarm can be raised by, for example, illuminating an indicator, activating an audible alarm, and/or transmitting a message or alert to remote device, such as a smart phone, tablet, server, computer, security company or personnel device, etc.

It is also contemplated that a tamper condition can be detected even if the final gear 110 is not in the home position at the initiation of the forward mode of operation. This can occur, for example, when a tamper was previously detected, or if the controller 140 resets during operation of electric motor 72. In this situation, it is possible controller 140 does not observe all the states of state machine 900 from forward start state 904. In response to this issue, controller 140 is configured to store in volatile memory whether or not the home position for final gear 110 was reached in the previous run of electric motor 72.

At the beginning of the next run of electric motor 72, this information is read from the volatile memory. If the home position was reached, the unlocking or locking operation proceeds normally with state machine 900 as discussed above. If the home position was not reached in the previous run of electric motor 72, controller 140 attempts to find the forward start state 904 based on the sensed magnetic field values. If the forward start state 904 is located, the state machine 900 is used during the forward mode of operation, and the maximum and minimum reverse run time values are determined and the state machine 900.

If controller 140 fails to locate the forward start state 904, state machine 900 is skipped during the forward mode of operation. Electric motor 72 is operated during the forward mode without checking for tamper conditions. During the subsequent reverse mode of operation, the next state is the reverse end state 1010 for a locking operation. For an unlocking operation, the reverse mode states 920, 922, 924, 926 are combined into a single reverse hump state that extends from location 916 to the reverse home state 928 in which final gear 110 is positioned in the home position. The sensed magnetic field values during the reverse mode of operation can then be compared to expected values over the reverse hump state and reverse home state to determine if a tamper condition is present. Hard-coded values stored in controller 140 can be used for the maximum and minimum reverse run times in this situation.

In addition to detecting tamper conditions, the present disclosure is also applicable to determining an amount the deadbolt 40 is extended or retracted, such as by using state machine 900. For example, the various states of state machine 900 correspond to various rotational positions of final gear 110. These positions of final gear 110 can be associated with the amount or percentage that deadbolt 40 is extended or retracted.

Other embodiments of other processes for determining the current state of state machine 900 are also contemplated. For example, the current state can initially be set to an UNKNOWN state. Controller 140 then checks whether the sensed magnetic field value is between upper and lower limits. When controller 40 determines the magnetic field value is between these upper and lower limits, controller 140 moves to ramp state 902. The magnetic field value has to stay between the upper and lower limits to stay in the ramp state 902. Controller 140 then checks whether the previous magnetic field value is less than the current magnetic field value and, if so, increments a COUNT variable. If there are a predetermined number of readings where the previous/current magnetic field values satisfy this condition, and the magnetic field value is greater than or equal to forward start state threshold, then controller 140 moves into the forward start state 904 of state machine 900 and starts a timer.

While in the forward start state 904, the sensed magnetic field value has to fall within a predetermined range of expected magnetic field values for the forward start state 904. If not, a tamper condition is indicated and the state machine 900 is stopped while electric motor 72 continues to operate to extend or retract the deadbolt 40. When the magnet field value increases to the upper limit for the forward start state 904, controller 140 checks whether the lock is in a locking or unlocking operation. If a locking operation, state machine 900 enters the forward end state 1006. If an unlocking operation, state machine 900 enters the forward mid state 906.

If in the locking operation, the sensed magnetic field values must lie within a predetermined range of expected magnetic field values for the forward end state 1006. If not, a tamper condition is indicated. Controller 140 continues in the forward mode of operation until a stall of electric motor 72 occurs at location 1008, after which a reverse mode of operation is initiated at the reverse end state 1010 unless there was a tamper condition detected.

If in an unlocking operation, state machine 900 is in forward mid state 906, and the sensed magnetic field values have to be within a predetermined range of expected magnetic field values associated with mid state range 906. If the sensed magnetic field stays within the predetermined range, controller 140 counts how many readings have been made within the predetermined range of expected magnetic field values. Once the sensed magnetic field exceeds a threshold value, controller 140 checks if the counts exceeds a threshold count. If above the threshold count, state machine 900 transitions to forward rise state 908. If the count is less than the count threshold, a tamper condition is indicated. Transitioning through forward mid state 906 thus requires sensed magnetic field values to be maintained between upper and lower thresholds for at least a threshold amount of time before moving to forward rise state 908.

In forward rise state 908, controller 140 ensures that the sensed magnetic field values are above a rise state threshold. If the sensed magnetic field value is below the rise state threshold, a tamper condition is indicated. If above the rise state threshold, controller 140 checks whether the sensed magnetic field value is greater than the peak 910. Peak 910 can be a dynamic value that is calculated during calibration and is stored in controller 140 as a constant value. Controller 140 assigns greater magnetic field values to peak 910 and increases the count. If the peak 910 is greater than a threshold amount and a minimum number of counts of increasing magnetic field values are sensed, controller 140 transitions to forward fall state 912. If not, controller 140 decrements the count (which accounts for some errors in the reading).

In the forward fall state 912 and forward end state 914, controller 140 checks that the sensed magnetic field values remain in the range of expected magnetic field values. A flag indicating an unlocked state can be used to determine whether deadbolt 40 is completely unlocked or not after forward end state 914. A similar process can then be used for the reverse mode of operation.

Various aspects of the present disclosure are contemplated. For example, according to one aspect, a method for detecting tampering with a deadbolt system is provided. The method includes transmitting a lock command or an unlock command to an electric motor from a controller; rotating at least one gear with the electric motor to extend or retract a deadbolt operably connected thereto in response to the lock command or the unlock command, where the at least one gear includes a first magnet and a second magnet that rotate with the at least one gear; sensing, with a stationary magnetic sensor, magnetic field values from at least one of the first and second magnets while rotating the at least one gear; comparing the magnetic field values sensed during the rotating with expected magnetic field values; and determining a tamper condition of the deadbolt system in response to the sensed magnetic field values falling outside a predetermined range for the expected magnetic field values.

In an embodiment, the predetermined range extends from a positive peak to a negative peak for the expected magnetic field values, and the tamper condition is determined in response to the sensed magnetic field values being more than the positive peak or less than the negative peak for the expected magnetic field values.

In an embodiment, the predetermined range includes a plurality of predetermined ranges that vary according to a state of the electric motor. The state of the electric motor depends on a position of the at least one gear relative to the stationary magnetic sensor. The tamper condition is determined in response to the sensed magnetic field values falling outside the predetermined range for the expected magnetic field values that correspond to a current state the electric motor.

In an embodiment, the method includes determining the tamper condition in response to one or more of: a reverse run time for the electric motor to return to a home position exceeds a minimum or maximum time threshold; a run time for the electric motor exceeds a predetermined threshold that is associated with a current state of the electric motor that is based on a position and direction of rotation of the at least one gear; and a forward run time for the electric motor exceeds a predetermined threshold without the electric motor changing from the current state.

In an embodiment, the method includes determining a home position of the at least one gear based on one of the first and second magnets; operating the electric motor in a forward mode from the home position to extend the deadbolt in a locking operation or to retract the deadbolt in an unlocking operation; and operating the electric motor in a reverse mode to position the at least one gear in the home position after extending the deadbolt to a locked position in the locking operation or after retracting the deadbolt to an unlocked position in the unlocking operation.

In a further embodiment, each of the forward mode and the reverse mode includes a plurality of states for the electric motor that are based on a position of the at least one gear relative to the stationary magnetic sensor. The expected magnetic field values vary according to which of the plurality of states the electric motor is currently operating.

In yet a further embodiment, the expected magnetic field values include a range of magnetic field intensities, and the range varies according to the plurality of states.

In yet a further embodiment, during the unlocking operation, the plurality of states of the forward and reverse mode includes: a forward start state, a forward mid state, a forward rise state, a forward fall state, a forward end state, a reverse mid state, a reverse rise state, a reverse fall state, a reverse end state, and a reverse home state. During the locking operation, the plurality of states of the forward and reverse mode includes: a forward start state, a forward end state, a reverse end state, and a reverse home state.

In yet a further embodiment, each of the plurality of states has a time limit for which the electric motor can operate in that particular state. The method includes determining the tamper condition in response to the time limit being exceeded.

In a further embodiment, in response to determining the tamper condition while operating in the forward mode, the method includes continuing to rotate the at least one gear with the electric motor to extend the deadbolt in the locking operation or to retract the deadbolt in the unlocking operation until reaching a stall condition, a time limit condition, the locked position, or the unlocked position; and suspending the reverse mode of operation to the home position.

In a further embodiment, in response to determining the tamper condition while operating in the reverse mode, stopping the electric motor.

According to another aspect of the present disclosure, a deadbolt system includes an electric motor and at least one gear having a first magnet and a second magnet attached thereto. The at least one gear is rotatable by the electric motor. The deadbolt system also includes a deadbolt movable between an extended position and a retracted position by rotation of the at least one gear by the electric motor, and a stationary magnetic sensor operable to sense magnetic field values from the first magnet and the second magnet. One of the first and second magnets indicates a home position for the at least one gear. The deadbolt system also includes a controller in electrical communication with the stationary magnetic sensor to control operation of the electric motor. The controller includes a memory comprising a plurality of instructions stored thereon that, in response to execution by the controller, cause the controller to: compare the magnetic field values sensed during rotation of the at least one gear with expected magnetic field values; and provide an output indicating a tamper condition of the deadbolt system in response to the sensed magnetic field values falling outside a predetermined range for the expected magnetic field values.

In an embodiment, the stationary magnetic sensor is the only stationary magnet sensor in electrical communication with the controller.

In an embodiment, the predetermined range extends from a positive peak to a negative peak for the expected magnetic field values. The plurality of instructions stored on the controller cause the controller to provide the output indicating the tamper condition in response to the sensed magnetic field values being more than the positive peak or less than the negative peak for the expected magnetic field values.

In an embodiment, the predetermined range includes a plurality of predetermined ranges that vary according to a state of the electric motor. The state of the electric motor depends on a position of the at least one gear relative to the stationary magnetic sensor. The plurality of instructions stored on the controller cause the controller to provide the output indicating the tamper condition in response to the sensed magnetic field values falling outside the predetermined range that corresponds to a current state the electric motor.

In an embodiment, the plurality of instructions stored on the controller cause the controller to provide the output indicating the tamper condition in response to any one of: a reverse run time for the electric motor to return to a home position exceeds a minimum or maximum time threshold; a run time for the electric motor exceeds a predetermined threshold that is associated with a current state of the electric motor that is based on a position and direction of rotation of the at least one gear; and a forward run time for the electric motor exceeds a predetermined threshold without the electric motor changing states.

In an embodiment, the plurality of instructions stored on the controller cause the controller to: determine a home position of the at least one gear based on one of the first and second magnets; operate the electric motor in a forward mode from the home position to extend the deadbolt in a locking operation or to retract the deadbolt in an unlocking operation; and operate the electric motor in a reverse mode to position the at least one gear in the home position after extending the deadbolt to a locked position in the locking operation or after retracting the deadbolt to an unlocked position in the unlocking operation.

According to another aspect of the present disclosure, an apparatus for detecting magnetic tampering of a deadbolt system is provided. The apparatus includes a controller configured to control operation of an electric motor drivably coupled to a deadbolt through at least one gear. The at least one gear includes a first magnet and a second magnet angularly spaced from the first magnet. The controller is in electrical communication with a stationary magnetic sensor the senses magnetic field values from the first and second magnets to control operation of the electric motor. The controller includes a memory comprising a plurality of instructions stored thereon that, in response to execution by the controller, causes the controller to: compare the magnetic field values sensed during rotation of the at least one gear with expected magnetic field values; and provide an output indicating a tamper condition of the deadbolt system in response to the sensed magnetic field values falling outside a predetermined range for the expected magnetic field values.

In an embodiment, the plurality of instructions further cause the controller to provide the output indicating the tamper condition in response to any one of: a reverse run time for the electric motor to return to a home position exceeds a minimum or maximum time threshold; a run time for the electric motor exceeds a predetermined threshold that is associated with a current state of the electric motor that is based on a position and direction of rotation of the at least one gear; and a forward run time for the electric motor exceeds a predetermined threshold without the electric motor changing states.

In an embodiment, the plurality of instructions further cause the controller to: determine a home position of the at least one gear based on one of the first and second magnets; operate the electric motor in a forward mode from the home position to extend the deadbolt in a locking operation or to retract the deadbolt in an unlocking operation; and operate the electric motor in a reverse mode to position the at least one gear in the home position after extending the deadbolt to a locked position in the locking operation or after retracting the deadbolt to an unlocked position in the unlocking operation.

What is claimed is:

1. A method for detecting tampering with a deadbolt system, the method comprising:
transmitting a lock command or an unlock command to an electric motor from a controller:
rotating at least one gear with the electric motor to extend or retract a deadbolt operably connected thereto in response to the lock command or the unlock command, wherein the at least one gear includes a first magnet and a second magnet that rotate with the at least one gear;
sensing, with a stationary magnetic sensor, magnetic field values from at least one of the first and second magnets while rotating the at least one gear;
comparing the magnetic field values sensed during the rotating with expected magnetic field values; and
determining a tamper condition of the deadbolt system in response to the sensed magnetic field values falling outside a predetermined range for the expected magnetic field values.

2. The method of claim 1, wherein the predetermined range extends from a positive peak to a negative peak for the expected magnetic field values, and the tamper condition is determined in response to the sensed magnetic field values being more than the positive peak or less than the negative peak for the expected magnetic field values.

3. The method of claim 1, wherein:
the predetermined range includes a plurality of predetermined ranges that vary according to a state of the electric motor, the state of the electric motor depending on a position of the at least one gear relative to the stationary magnetic sensor; and
the tamper condition is determined in response to the sensed magnetic field values falling outside the predetermined range for the expected magnetic field values that correspond to a current state the electric motor.

4. The method of claim 1, further comprising determining the tamper condition in response to one or more of:
a reverse run time for the electric motor to return to a home position exceeds a minimum or maximum time threshold;
a run time for the electric motor exceeds a predetermined threshold that is associated with a current state of the electric motor that is based on a position and direction of rotation of the at least one gear; and
a forward run time for the electric motor exceeds a predetermined threshold without the electric motor changing from the current state.

5. The method of claim 1, further comprising:
determining a home position of the at least one gear based on one of the first and second magnets;
operating the electric motor in a forward mode from the home position to extend the deadbolt in a locking operation or to retract the deadbolt in an unlocking operation; and
operating the electric motor in a reverse mode to position the at least one gear in the home position after extending the deadbolt to a locked position in the locking operation or after retracting the deadbolt to an unlocked position in the unlocking operation.

6. The method of claim 5, wherein:
each of the forward mode and the reverse mode includes a plurality of states for the electric motor that are based on a position of the at least one gear relative to the stationary magnetic sensor; and
the expected magnetic field values vary according to which of the plurality of states the electric motor is currently operating.

7. The method of claim 6, wherein the expected magnetic field values include a range of magnetic field intensities, and the range varies according to the plurality of states.

8. The method of claim 7, wherein:
during the unlocking operation, the plurality of states of the forward and reverse mode includes:
a forward start state, a forward mid state, a forward rise state, a forward fall state, a forward end state, a reverse mid state, a reverse rise state, a reverse fall state, a reverse end state, and a reverse home state; and
during the locking operation, the plurality of states of the forward and reverse mode includes:
a forward start state, a forward end state, a reverse end state, and a reverse home state.

9. The method of claim 8, wherein each of the plurality of states has a time limit for which the electric motor can operate in that particular state, and further comprising determining the tamper condition in response to the time limit being exceeded.

10. The method of claim 5, wherein, in response to determining the tamper condition while operating in the forward mode:
continue rotating the at least one gear with the electric motor to extend the deadbolt in the locking operation or to retract the deadbolt in the unlocking operation until reaching a stall condition, a time limit condition, the locked position, or the unlocked position; and
suspending the reverse mode of operation to the home position.

11. The method of claim 5, wherein, in response to determining the tamper condition while operating in the reverse mode, stopping the electric motor.

12. A deadbolt system, comprising:
an electric motor;
at least one gear having a first magnet and a second magnet attached thereto, the at least one gear rotatable by the electric motor;
a deadbolt movable between an extended position and a retracted position by rotation of the at least one gear by the electric motor;
a stationary magnetic sensor operable to sense magnetic field values from the first magnet and the second magnet, wherein one of the first and second magnets indicates a home position for the at least one gear; and
a controller in electrical communication with the stationary magnetic sensor to control operation of the electric motor, wherein the controller includes a memory comprising a plurality of instructions stored thereon that, in response to execution by the controller, causes the controller to:
compare the magnetic field values sensed during rotation of the at least one gear with expected magnetic field values; and
provide an output indicating a tamper condition of the deadbolt system in response to the sensed magnetic field values falling outside a predetermined range for the expected magnetic field values.

13. The deadbolt system of claim 12, wherein the stationary magnetic sensor is the only stationary magnet sensor in electrical communication with the controller.

14. The deadbolt system of claim 12, wherein the predetermined range extends from a positive peak to a negative peak for the expected magnetic field values, and the plurality of instructions stored on the controller cause the controller to provide the output indicating the tamper condition in response to the sensed magnetic field values being more than the positive peak or less than the negative peak for the expected magnetic field values.

15. The deadbolt system of claim 12, wherein the predetermined range includes a plurality of predetermined ranges that vary according to a state of the electric motor, the state of the electric motor depending on a position of the at least one gear relative to the stationary magnetic sensor, and the plurality of instructions stored on the controller cause the controller to provide the output indicating the tamper condition in response to the sensed magnetic field values falling outside the predetermined range that corresponds to a current state the electric motor.

16. The deadbolt system of claim 12, wherein the plurality of instructions stored on the controller cause the controller to provide the output indicating the tamper condition in response to any one of:
a reverse run time for the electric motor to return to a home position exceeds a minimum or maximum time threshold;
a run time for the electric motor exceeds a predetermined threshold that is associated with a current state of the electric motor that is based on a position and direction of rotation of the at least one gear; and
a forward run time for the electric motor exceeds a predetermined threshold without the electric motor changing states.

17. The deadbolt system of claim 12, wherein the plurality of instructions stored on the controller cause the controller to:
determine a home position of the at least one gear based on one of the first and second magnets;
operate the electric motor in a forward mode from the home position to extend the deadbolt in a locking operation or to retract the deadbolt in an unlocking operation; and
operate the electric motor in a reverse mode to position the at least one gear in the home position after extending the deadbolt to a locked position in the locking operation or after retracting the deadbolt to an unlocked position in the unlocking operation.

18. An apparatus for detecting magnetic tampering of a deadbolt system, the apparatus comprising:
a controller configured to control operation of an electric motor drivably coupled to a deadbolt through at least one gear, the at least one gear including a first magnet and a second magnet angularly spaced from the first magnet, the controller in electrical communication with a stationary magnetic sensor the senses magnetic field values from the first and second magnets to control operation of the electric motor, wherein the controller includes a memory comprising a plurality of instructions stored thereon that, in response to execution by the controller, causes the controller to:
compare the magnetic field values sensed during rotation of the at least one gear with expected magnetic field values; and
provide an output indicating a tamper condition of the deadbolt system in response to the sensed magnetic field values falling outside a predetermined range for the expected magnetic field values.

19. The apparatus of claim 18, wherein the plurality of instructions further cause the controller to provide the output indicating the tamper condition in response to any one of:
a reverse run time for the electric motor to return to a home position exceeds a minimum or maximum time threshold;
a run time for the electric motor exceeds a predetermined threshold that is associated with a current state of the electric motor that is based on a position and direction of rotation of the at least one gear; and
a forward run time for the electric motor exceeds a predetermined threshold without the electric motor changing states.

20. The apparatus of claim 18, wherein the plurality of instructions further cause the controller to:
determine a home position of the at least one gear based on one of the first and second magnets;
operate the electric motor in a forward mode from the home position to extend the deadbolt in a locking operation or to retract the deadbolt in an unlocking operation; and
operate the electric motor in a reverse mode to position the at least one gear in the home position after extending the deadbolt to a locked position in the locking operation or after retracting the deadbolt to an unlocked position in the unlocking operation.
